(19) United States
(12) Patent Application Publication
(10) Pub. No.: US 2011/0014038 A1
(43) Pub. Date: Jan. 20, 2011

(54) WIND TURBINE WITH SKELETON-AND-SKIN STRUCTURE

(75) Inventors: Michael J. Werle, West Hartford, CT (US); William Scott Keeley, Charlestown, RI (US); Thomas J. Kennedy, III, Wilbraham, MA (US); Walter M. Presz, JR., Wilbraham, MA (US); Robert Dold, Monson, MA (US)

Correspondence Address: FAY SHARPE LLP, 1228 Euclid Avenue, 5th Floor, The Halle Building, Cleveland, OH, 44115, US

(73) Assignee: FloDesign Wind Turbine Corporation, Wilbraham, MA (US)

(21) Appl. No.: 12/823,220

(22) Filed: Jun. 25, 2010

Related U.S. Application Data
(63) Continuation-in-part of application No. 12/555,446, filed on Sep. 8, 2009.
Application No. 12/555,446 is a continuation-in-part of application No. 12/054,050, filed on Mar. 24, 2008.
(60) Provisional application No. 61/191,358, filed on Sep. 8, 2008.
(60) Provisional application No. 60/919,588, filed on Mar. 23, 2007.

(51) Int. Cl. F03D 1/04; F03D 11/00; B23P 15/00

(52) U.S. Cl. 415/200; 415/214.1; 415/211.2; 29/888.025

(57) ABSTRACT

A wind turbine comprises a turbine shroud and optionally an ejector shroud. The turbine shroud and/or the ejector shroud include a skeleton support structure, with a skin covering at least a portion of the turbine shroud and/or ejector shroud skeleton. In other embodiments, leading and trailing edges of the turbine shroud and/or ejector shroud are made of a rigid material and are not covered by the skin of the shroud.

This application is a continuation-in-part application of U.S. patent application Ser. No. 12/555,446, filed Sept. 8, 2009, which claims priority from U.S. Provisional Patent Application Ser. No. 61/191,358, filed on Sept. 8, 2008. This application is also a continuation-in-part from U.S. patent application Ser. No. 12/054,050, filed Mar. 24, 2008, which claimed priority from U.S. Provisional Patent Application Ser. No. 60/919,588, filed Mar. 23, 2007. Applicants hereby fully incorporate the disclosure of these applications by reference in their entirety.

### BACKGROUND

The present disclosure relates to wind turbines, particularly shrouded wind turbines with shrouds having a skeleton-and-skin structure. The shrouds include a skeleton support structure with a skin covering at least a portion of the skeleton structure.

Conventional wind turbines have three blades and are oriented or pointed into the wind by computer controlled motors. These turbines typically require a supporting tower ranging from 60 to 90 meters in height. The blades generally rotate at a rotational speed of about 10 to 22 rpm. A gear box is commonly used to step up the speed to drive the generator, although some designs may directly drive an annular electric generator. Some turbines operate at a constant speed. However, more energy can be collected by using a variable speed turbine and a solid state power converter to interface the turbine with the generator. Although Horizontal Axis Wind Turbines also known as HAWTs have achieved widespread usage, their efficiency is not optimized. In particular, they will not exceed a limit of 59.3% efficiency known as the Betz limit in capturing the potential energy of the wind passing through it.

Several problems are associated with HAWTs in both construction and operation. The tall towers and long blades are difficult to transport. Massive tower construction is required to support the heavy blades, gearbox, and generator. Very tall and expensive cranes and skilled operators are needed for installation. In operation, existing HAWTs require an additional yaw control mechanism to turn the blades toward the wind. HAWTs typically have a high angle of attack on their airfoils that do not lend themselves to variable changes in wind flow. HAWTs are difficult to operate in near ground, turbulent winds. Furthermore, ice build-up on the nacelle and the blades can cause power reduction and safety issues. Tall HAWTs may affect airport radar. Their height also makes them obtrusively visible across large areas and thus creating objectionable appearance of the landscape. Additionally, downwind variants suffer from fatigue and structural failure caused by turbulence.

Therefore, it has been desired to reduce one or more of the above noted difficulties and to modify the mass and size of wind turbines.

### BRIEF DESCRIPTION

The present disclosure relates to wind turbines having, in part, reduced mass and size. In particular, the wind turbines include a turbine shroud and/or an ejector shroud having a skeleton-and-skin structure. Such wind turbines are lighter and allow for less substantial supports in the turbine body. The exterior skin may also add strength, water resistance, ultra violet (UV) stability, and other functionality.

Disclosed in several exemplary versions or embodiments is a wind turbine having a turbine shroud, the turbine shroud comprising a first rigid structural member, a second rigid structural member, a plurality of first internal ribs connecting the first rigid structural member to the second rigid structural member, and a skin covering at least the plurality of ribs. The skin may comprise a fabric or a film such as a polymer, or may be a combination of fabric and film.

The wind turbine may further include an ejector shroud and one or more trusses connecting the ejector shroud to the turbine shroud. The ejector shroud may comprise an ejector shroud first rigid structural member, an ejector shroud second rigid structural member, a plurality of second internal ribs connecting the ejector shroud first rigid structural member to the ejector shroud second rigid structural member, and an ejector skin covering at least the plurality of second internal ribs. The ejector skin may comprise a fabric or a film such as a polymer.

In some embodiments, the turbine shroud first rigid structural member and the ejector shroud first rigid structural member each have a substantially circular shape. The turbine shroud second rigid structural member and the ejector shroud second rigid structural member may each have a circular crenellated circumference that forms a plurality of mixing lobes.

Leading and trailing edges of the turbine shroud may optionally be covered by the turbine skin. Leading and trailing edges of the ejector shroud may also be optionally covered by the ejector skin.

The wind turbine includes an impeller, wherein the turbine shroud is disposed about the impeller.

The turbine skin may comprise a skin formed of polyurethane-polyurea copolymer material. The turbine skin may be reinforced with a highly crystalline polyethylene. The turbine skin may also be reinforced with para-aramid fibers or a polyaramide.

The turbine shroud second structural member may have a circular crenellated circumference. Leading and trailing edges of the turbine shroud may comprise a rigid material. The rigid material may be selected from the group consisting of polymers, metals, and mixtures thereof. The rigid material may be a glass reinforced polymer.

The turbine skin may comprise a plurality of layers.

Disclosed in other embodiments is a wind turbine comprising a turbine shroud, an ejector shroud, and one or more trusses connecting the turbine shroud to the ejector shroud. The turbine shroud comprises a first rigid structural member defining a leading edge of the turbine shroud, a second rigid structural member defining a trailing edge of the turbine shroud, a plurality of first internal ribs connecting the first rigid structural member to the second rigid structural member, and a turbine shroud skin covering at least the plurality of first internal ribs and comprising a fabric or a polymer film. The ejector shroud comprises an ejector shroud first rigid structural member defining a leading edge of the ejector shroud, an ejector shroud second rigid structural member defining a trailing edge of the ejector shroud, a plurality of second internal ribs connecting the ejector shroud first rigid structural member to the ejector shroud second rigid structural member, and an ejector shroud skin covering at least the plurality of second internal ribs and comprising a fabric or a polymer film. The first rigid structural member and the ejector shroud first rigid structural member may each have a substantially circular shape. The second rigid structural member and the ejector shroud second rigid structural member may each have a circular crenellated circumference.

Disclosed in embodiments is a wind turbine including a turbine shroud, the turbine shroud comprising: a turbine shroud first rigid structural member; a turbine shroud second rigid structural member; a plurality of internal ribs connecting the first rigid structural member to the second rigid structural member; and a turbine skin covering at least a portion of the plurality of ribs, wherein the skin is formed of one of a fabric or a polymer film. Mixing lobes are formed on a trailing edge of the turbine shroud, or in other words around an outlet end of the turbine shroud.

In still further embodiments, a wind turbine is provided that comprises a turbine shroud, an ejector shroud, and at least one truss connecting the turbine shroud to the ejector shroud; wherein the turbine shroud comprises: a first rigid structural member defining a leading edge of the turbine shroud; a second rigid structural member defining a trailing edge of the turbine shroud; a plurality of first internal ribs connecting the first rigid structural member to the second rigid structural member; and a turbine shroud skin covering at least a portion of the plurality of first internal ribs and comprising one of a fabric and a polymer; wherein the ejector shroud comprises: an ejector shroud first rigid structural member defining a leading edge of the ejector shroud; an ejector shroud second rigid structural member defining a trailing edge of the ejector shroud; a plurality of second internal ribs connecting the ejector shroud first rigid structural member to the ejector shroud second rigid structural member; and an ejector shroud skin covering at least a portion of the plurality of second internal ribs and comprising one of a fabric and a polymer; wherein the first rigid structural member and the ejector shroud first rigid structural member each have a substantially circular shape; and wherein the second rigid structural member and the ejector shroud second rigid structural member each have a circular crenellated circumference. This results in the formation of mixing lobes on the outlet ends of both the turbine shroud and the ejector shroud.

A method of making a wind turbine is also disclosed. The method comprises: (a) providing an impeller; (b) forming a skeleton structure and covering at least a portion of the skeleton structure with a skin selected from one of a fabric and a polymer film and forming a turbine shroud; and, (c) disposing the shroud about the impeller.

These and other non-limiting features or characteristics of the present disclosure will be further described below.

### BRIEF DESCRIPTION OF THE DRAWINGS

The following is a brief description of the drawings, which are presented for the purposes of illustrating the disclosure set forth herein and not for the purposes of limiting the same.

FIG. 1 is a perspective view of a first exemplary embodiment of a wind turbine of the present disclosure.

FIGS. 2A-2C are perspective views showing the progressive stages of the construction process of an additional exemplary embodiment of the wind turbine of the present disclosure.

FIG. 2D is a view similar to FIG. 2A of another embodiment of the shroud skeleton.

FIGS. 3A-3C are side views of various exemplary internal rib members employed in the wind turbine of the present disclosure.

FIGS. 3D-3E show alternate embodiments of wind turbines employing internal rib members such as those shown in FIGS. 3A-3C.

FIG. 4 is a perspective view of the partially completed sub-skeletons of a turbine shroud and ejector shroud of an exemplary wind turbine of the present disclosure.

FIG. 5 is a perspective view of the turbine shroud sub-skeleton of FIG. 4.

FIG. 6 is a perspective view of the ejector shroud sub-skeleton of FIG. 4.

FIG. 7 is a perspective view of the completed sub-skeletons of the turbine shroud and ejector shroud of FIG. 4.

FIG. 8 is a perspective view of the sub-skeletons of FIG. 7, illustrating a portion of the skins attached to the exteriors of the turbine shroud sub-skeleton and the ejector shroud sub-skeleton.

FIG. 9 is a perspective view of another exemplary embodiment of a wind turbine of the present disclosure having a pair of wing-tabs for wind alignment.

FIG. 10 is a perspective view of another embodiment of the wind turbine of the present disclosure employing a rotor/stator assembly in combination with a turbine shroud and ejector shroud.

FIG. 11 is a cross-sectional view of the wind turbine of FIG. 10.

FIG. 12 is a smaller view of FIG. 11.

FIGS. 12A and 12B are enlarged views of portions of FIG. 11 illustrating the details of the mixing lobes on the ejector/mixer shroud.

### DETAILED DESCRIPTION

A more complete understanding of the components, processes, and apparatuses disclosed herein can be obtained by reference to the accompanying figures. These figures are merely schematic representations based on convenience and the ease of demonstrating the present development and are, therefore, not intended to indicate the relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range from about 2 to about 4″ also discloses the range “from 2 to 4.”

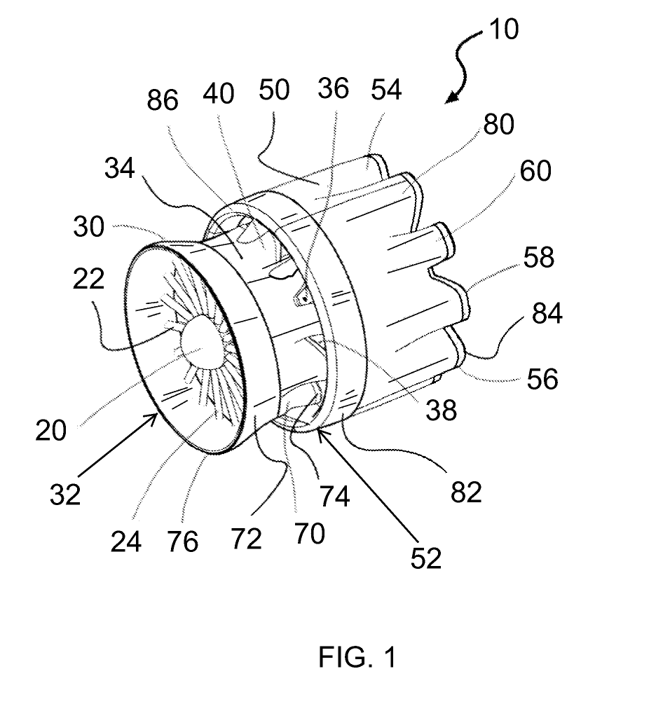

FIG. 1 is a perspective view of one embodiment of a wind turbine of the present disclosure, in a form also known as a mixer-ejector wind turbine (MEWT).

The MEWT is a new type of wind turbine that uses a shrouded impeller, prop, or rotor/stator to improve the efficiency of a wind turbine such that more power may be extracted for a turbine having the same area than other current types of wind turbines and particularly wind turbines employing free or open blade impellers. The MEWT accomplishes this by drawing air from a larger area than the most common type of wind turbine, the horizontal-axis wind turbine (HAWT).

A wind turbine can theoretically capture at most 59.3% of the potential energy of the wind passing through it, a maximum known as the Betz limit. The amount of energy captured by a wind turbine can also be referred to as the efficiency of the turbine. The MEWT can exceed the Betz limit. Generally, the wind turbine of the present disclosure includes a shroud that has a skeleton-and-skin structure. This structure provides a wind turbine which has a lower overall mass compared to a HAWT.

Referring to FIG. 1, the turbine 10 comprises an impeller 20 located at an intake end 32 of a turbine shroud 30. The impeller may generally be any assembly in which blades are attached to a shaft and able to rotate, allowing for the generation of power or energy from the force of wind rotating the blades. Exemplary impellers include a blade propeller arrangement or a rotor-and-stator combination. As illustrated in FIG. 1, the impeller 20 is a rotor/stator assembly. The stator 22 engages the turbine shroud 30, and the rotor disposed axially adjacent (not shown) engages a motor/generator (not shown). The stator 22 has a plurality of non-rotating blades 24 which re-direct or turn the air before it reaches the rotor. The blades of the rotor are thus caused to rotate a shaft (not shown) connected to the generator, generating power in the generator.

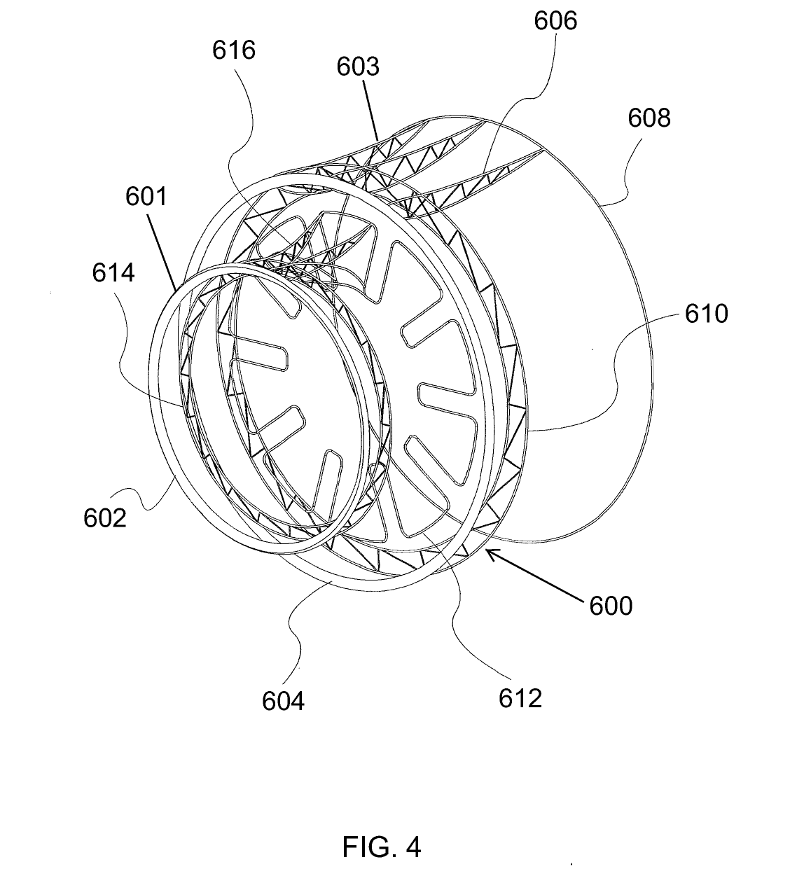

The shroud 30 comprises a ringed airfoil 34 which is generally cylindrical, with the airfoil configured to generate relatively lower pressure within the turbine shroud (i.e. the interior of the shroud) and relatively higher pressure outside the turbine shroud (i.e. the exterior of the shroud). In the present practice, the ringed airfoil is cambered, or has a cross-section shaped like an aircraft wing airfoil, as can be seen in FIGS. 4, 7, 12, 14, 17, and 19 of U.S. Patent Publication No. 2009/0087308, the entire disclosure of which is hereby incorporated by reference in its entirety. The impeller 20 and the motor/generator are contained within the turbine shroud 30. The turbine shroud 30 may also have mixer lobes 40 around an outlet or exhaust end of the shroud. The mixer lobes are generally uniformly distributed around the circumference of the exhaust end or located along the trailing edge 38 of the shroud. The mixer lobes generally cause the exhaust end 36 of the turbine shroud, where air exits, to have a generally convoluted or peak-and-valley shape about its circumference.

The turbine 10 also comprises an ejector shroud 50, which is engaged with the turbine shroud. The ejector shroud comprises a ringed airfoil 54 configured to be generally cylindrical and also having a cross-sectional airfoil shape. The camber of the ejector shroud is such that the lower pressure side of the airfoil is on the inside of the ejector shroud and the higher pressure side is on the outside of the ejector shroud, thus drawing higher energy air into the turbine to mix with the low energy air that has passed through the impeller 20. The camber of the ejector shroud 50 is generally greater than the camber of the turbine shroud 30. The ejector shroud may also have mixer lobes 60. The mixer lobes generally cause the exhaust end of the ejector 56, where air exits, to have a generally peak-and-valley or convoluted shape about its circumference. The mixer lobes are thus located along the trailing edge 58 of the ejector shroud 50.

The ejector shroud 50 has a larger diameter than the turbine shroud 30. The turbine shroud 30 engages the ejector shroud 50. In the embodiment shown in FIG. 1, the exhaust end 36 of the turbine shroud fits within the intake end indicated 52 of the ejector shroud, or the intake end 52 of the ejector shroud surrounds the exhaust end 36 of the turbine shroud. The turbine shroud 30 and ejector shroud 50 are sized so that air can flow through the annular space between them. Put another way, the ejector shroud 50 is concentrically disposed about the turbine shroud 30 and is downstream of the shroud 30. The impeller 20, turbine shroud 30, and ejector shroud 50 all share a common axis, i.e. are coaxial to each other.

The mixer lobes 40, 60 provide improved flow mixing and control. The turbine shroud and ejector shroud in the MEWT flow path provide high-energy air into the ejector shroud. The turbine shroud provides low-energy air into the ejector shroud, and the high-energy air outwardly surrounds, pumps, and mixes with the low-energy air.

A motor/generator (not shown), typically employed to generate electricity when the wind is driving the rotor, may also be used as a motor to drive the impeller 20, and thus draw air into and through the turbine 10, when the wind is insufficient to drive the rotor.

Referring again to FIG. 1, the turbine shroud 30 comprises a skin 70, a first rigid structural member 72, and a second rigid structural member 74. The first rigid member 72 defines the leading edge 76 of the shroud 30. The second rigid member 74 defines the trailing edge 38 with a plurality of lobes 40 around the circumference of the trailing edge. The first rigid structural member 72 is generally circular, when viewed from the front along the central axis. The first rigid structural member 72 provides a structure to support the impeller 20 and also acts as a funnel to channel air through the impeller. The rigid members 72, 74 are considered “rigid” relative to the skin 70.

The ejector shroud 50 also comprises a skin 80, a first rigid structural member 82, and a second rigid structural member 84. The first rigid member 82 defines the leading edge 86 of the ejector 50 and the second rigid member 84 defines the trailing edge 58 with a plurality of lobes 60 formed around the circumference of the trailing edge. Again, the rigid members 82, 84 are considered rigid relative to the skin 80.

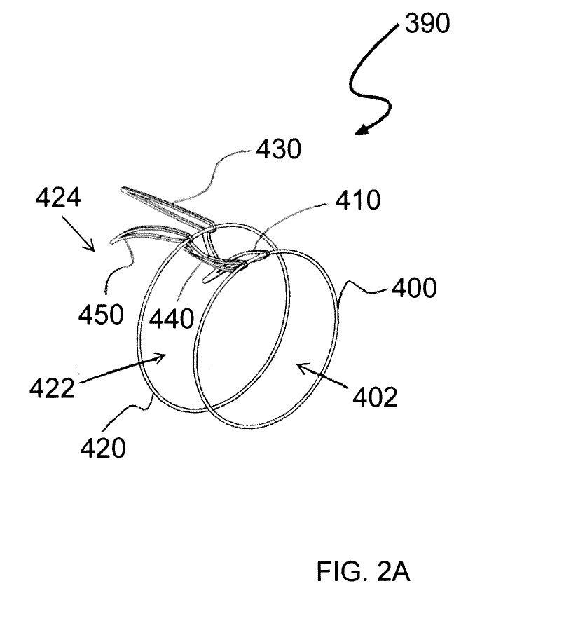

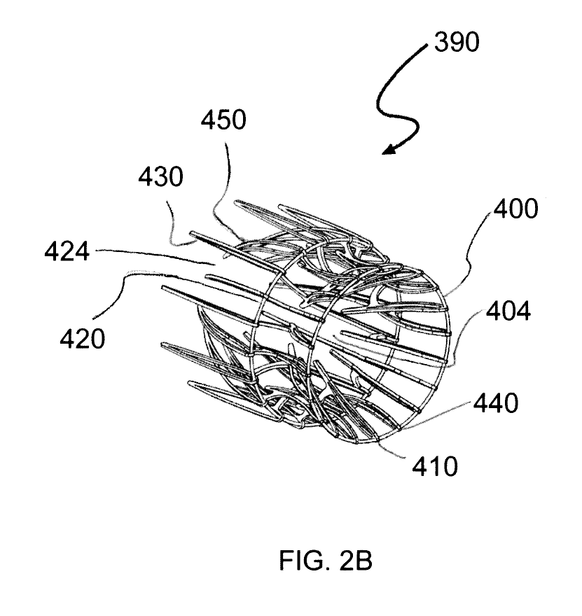

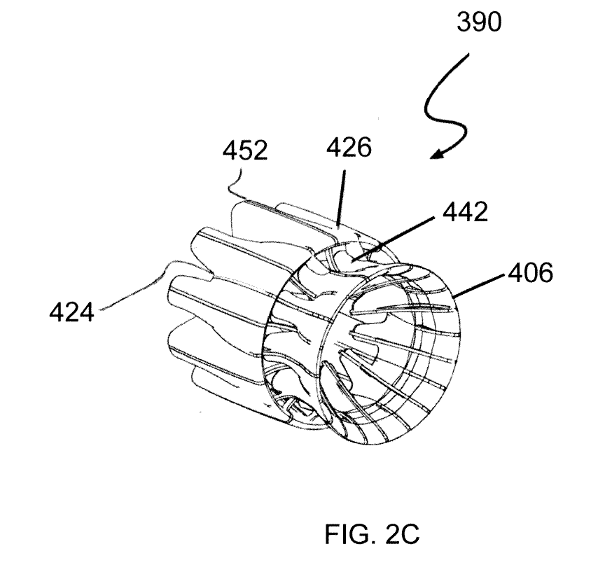

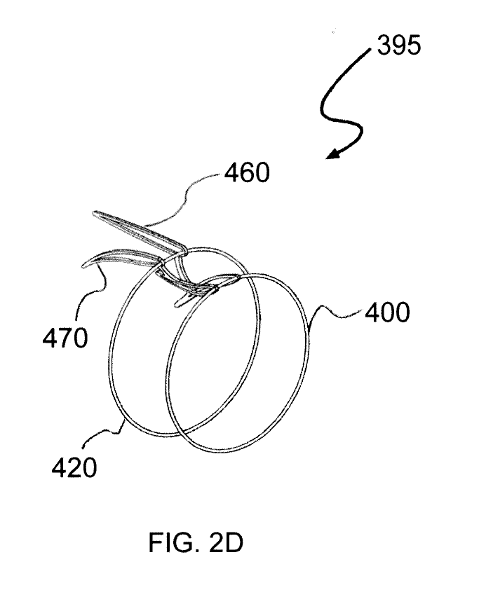

FIGS. 2A-2C show various stages of the construction of other exemplary embodiments of a shroud and/or ejector useful for a wind turbine of the present disclosure. The impeller is not shown in these figures. In FIGS. 2A, 2B and 2C, the combination shroud/ejector 390 comprises a circular member 400 and a plurality of shroud first rib members 410 which together define an intake end indicated generally at 402 and an exhaust end indicated generally at 404 for the turbine shroud. The circular member 400 and the plurality of shroud first rib members 410 are then covered by an exterior skin 406 of fabric or film material to complete the turbine shroud. The exhaust end 404 of the turbine shroud may have a smaller area than the intake end 402.

The ejector shroud comprises a generally circular member 420 and a plurality of ejector first rib members 430 which together define an intake end 422 and an exhaust end 424 for the ejector shroud. The circular member 420 and the plurality of ejector first rib members 430 are then covered by an exterior skin 426 of fabric or film material to complete the ejector shroud. The shroud circular member 400 and ejector circular member 420 may also be connected to each other by the shroud first rib members 410. In the present practice, the ribs and structural members are made of different materials than the skin.

In additional embodiments, the turbine shroud may include a plurality of shroud second rib members 440. The shroud second rib members 440 connect the shroud circular member 400 and ejector circular member 420 together. Together, the shroud first rib members 410 and shroud second rib members 440 define a plurality of mixer lobes 442 at the exhaust end 404 of the shroud. The shroud first rib members 410 and shroud second rib members 440 may have different shapes. Similarly, in additional embodiments, the ejector shroud may include a plurality of ejector second rib members 450. Together, the ejector first rib members 430 and ejector second rib members 450 when covered with skin 426 define a plurality of mixer lobes 452 at the exhaust end indicated generally at 424 of the ejector. Generally, the ejector first rib members 430 and ejector second rib members 450 have different shapes.

As seen in FIG. 2A, shroud first rib member 410 and ejector first rib member 430 connect to ejector circular member 420 at the same location. Similarly, shroud second rib member 440 and ejector second rib member 450 are shown connecting to ejector circular member 420 at the same location. However, connection at the same location on member 420 for the various rib members is not required.

Alternatively, as described in FIG. 2D the combination shroud/ejector 395 can be considered as comprising a first circular member 400, a second circular member 420, a plurality of first internal ribs 460, and a plurality of second internal ribs 470. The combination of the two circular members, first internal ribs, and second internal ribs define the shape of the turbine shroud, lobes on the turbine shroud, the ejector shroud, and lobes on the ejector shroud. The turbine shroud is defined by the area between the two circular members 400 and 420, while the ejector shroud is located downstream of the second circular member 420. Here, first internal rib 460 can be considered a one-piece combination of shroud first rib member 410 and ejector first rib member 430, while second internal rib 470 can be considered a one-piece combination of shroud second rib member 440 and ejector second rib member 450.

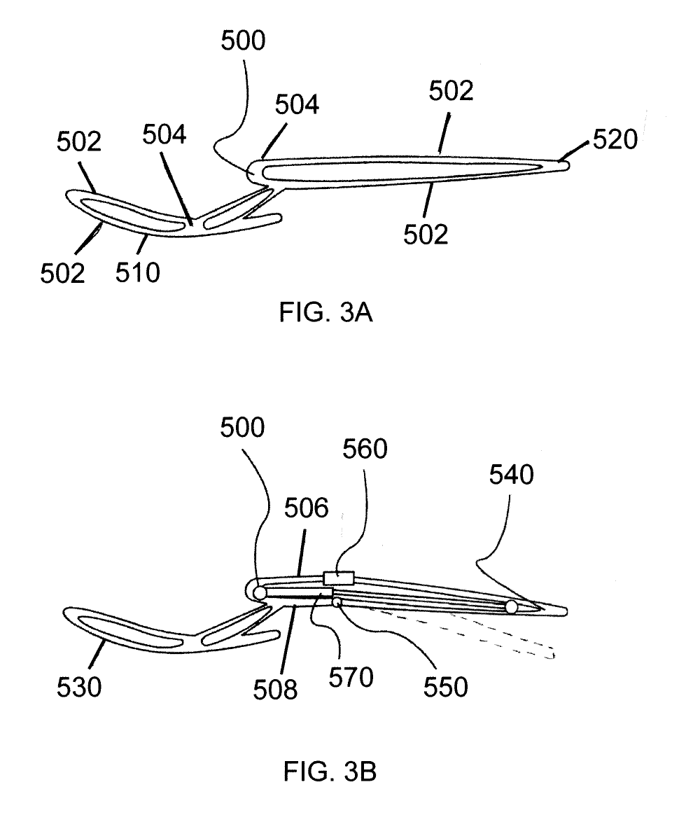

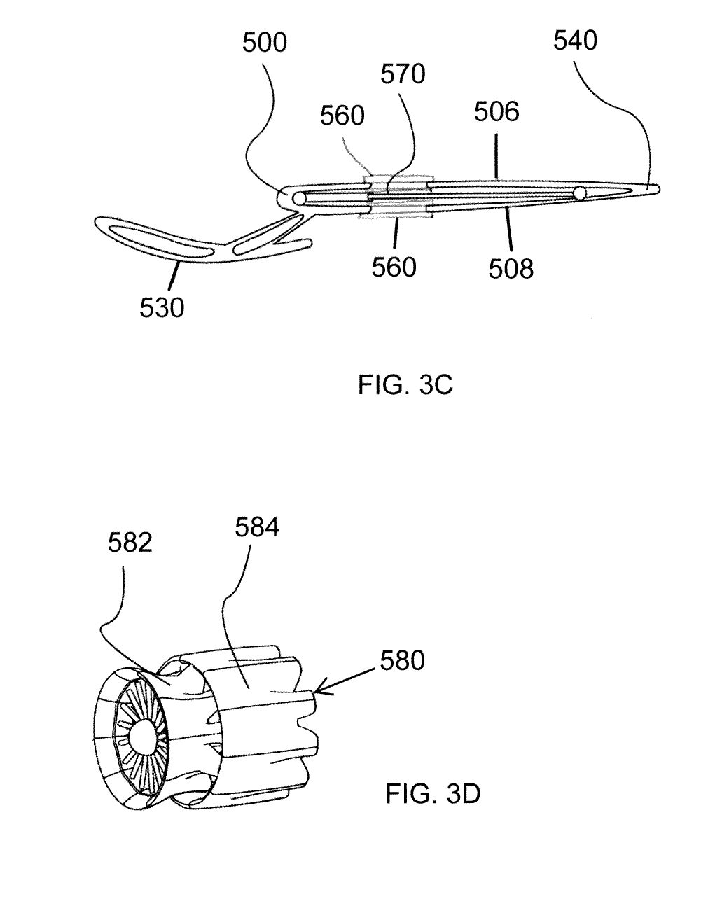

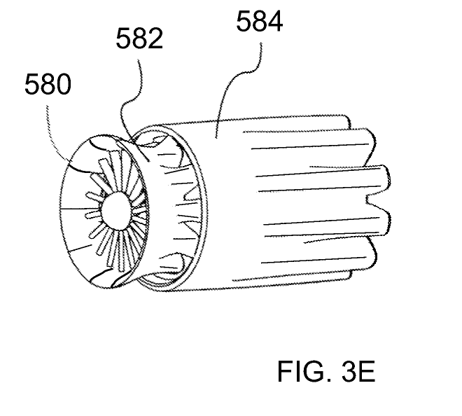

FIGS. 3A-C are side views of various embodiments of internal ribs suitable for use in embodiments as shown in FIGS. 2A-2C. In FIG. 3A, the rib 500 comprises an arcuate member 510 and a transverse member 520 integrally formed together to form a one piece generally rigid rib. The rib members are relatively lightweight and can be considered as beams 502 joined together by struts 504. It will be understood that the arcuate member 510 defines the shape of the turbine shroud, while the transverse member 520 defines the shape of the ejector shroud.

Referring to FIG. 3B, the rib 500 includes a stationary member 530 and a movable or actuated member 540. The stationary member 530 defines the shape of the turbine shroud, while the actuated member 540 defines the shape of the ejector shroud. The stationary member 530 and actuated member 540 are joined together along a bottom edge 508 by a pivot 550, which defines an angle between them. The stationary member 530 and actuated member 540 are joined together along a top edge 506 by a sleeve or linear motion member 560. An actuator 570 engages both the stationary member 530 and actuated member 540 so as to change the angle between them, thus changing the shape of the shroud and/or ejector. The solid outline in FIG. 3B shows a shortened or linear position, while the dashed outline shows a lengthened or angled position. This ability to change shape allows the overall skeleton of the turbine shroud or ejector shroud to move/change shape as well.

Referring to FIG. 3C, the stationary member 530 and actuated member 540 are joined together at both the top and bottom edges 506, 508 by a sleeve or linear motion member 560 which, together with the actuator 570, permits movement for changing the length of the rib 500. It will be understood that rib 500 is shown in the extended position in FIG. 3C.

FIG. 3D shows another embodiment of a wind turbine 580 with turbine shroud 582 and ejector shroud 584. Here, the rib members such as ribs 500 of the ejector (not shown) are in their axially shortened position. In FIG. 3E, the rib members of the ejector shroud 584 are in their axially lengthened position, resulting in an ejector of greater length and different air flow characteristics. Thus, the moveable nature of the rib members in the wind turbine enables changes in configuration to accommodate different wind conditions.

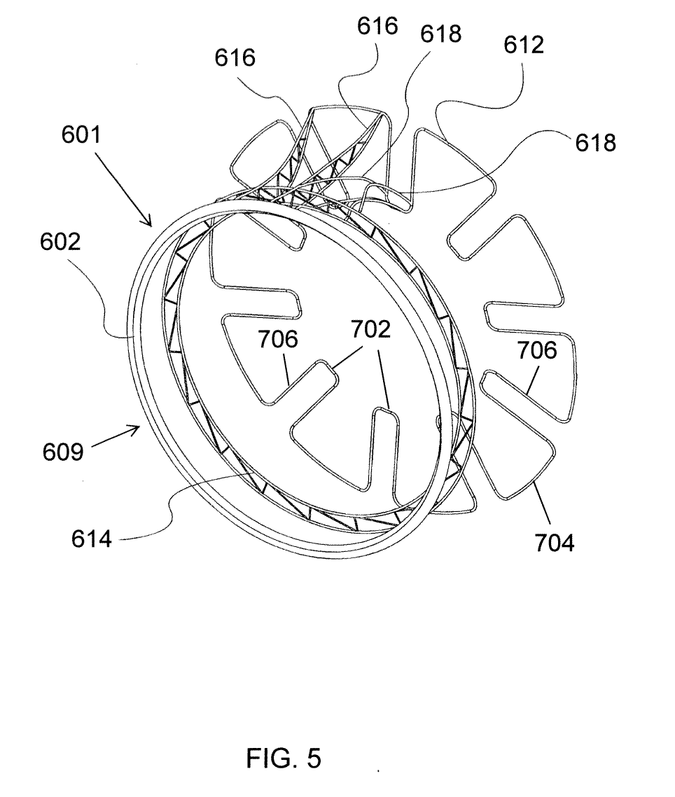

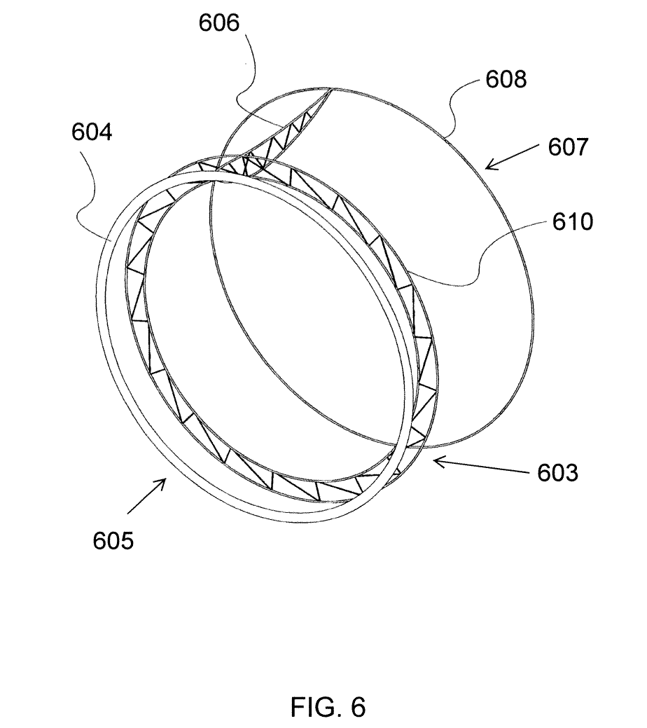

In FIGS. 4-8, the skeleton 600 of the wind turbine is considered to be made from two sub-skeletons, a turbine shroud sub-skeleton indicated generally at 601 and an ejector shroud sub-skeleton indicated generally at 603. FIG. 4 shows both sub-skeletons in their partially completed state. FIG. 5 shows only the turbine shroud sub-skeleton 601 in a partially completed state. FIG. 6 shows only the ejector shroud sub-skeleton 603 in a partially completed state.

Referring now to FIG. 5, the turbine shroud sub-skeleton 601 includes a turbine shroud front ring structure or first rigid structural member 602, a turbine shroud mixing structure or second rigid structural member 612, and a plurality of first internal ribs 616. A turbine shroud ring 614, which may be formed as a truss, may be included to further define the shape of the turbine shroud, as well as provide a connecting point between the turbine shroud sub-skeleton 601 and the ejector shroud sub-skeleton 603. When present, the ring truss 614 is substantially parallel to the turbine shroud front ring structure 602. A plurality of second internal ribs 618 may also be used to further define the shape of the mixing lobes. The first rigid structural member 602, ring truss 614, and second rigid structural member 612 are all connected to each other through the first internal ribs 616 and the second internal ribs 618. The first rigid structural member 602 and the second rigid structural member 612 are generally parallel to each other and perpendicular to the turbine axis.

The turbine shroud front ring structure 602 defines a front or inlet end 609 of the turbine shroud sub-skeleton 601, and a front or inlet end of the overall skeleton 600. The turbine shroud mixing structure 612 defines a rear end, outlet end, or exhaust end of the turbine shroud sub-skeleton 601. The turbine shroud front ring structure 602 defines a leading edge of the turbine shroud.

The second rigid structural member 612 is shaped somewhat like a gear with a circular crenellated or castellated shape. The second rigid structural member 612 can be considered as being formed from several inner circumferentially spaced arcuate portions 702 which each have the same radius of curvature. Those inner arcuate portions are preferably evenly spaced apart from each other. In those spaces between portions 702 are several outer arcuate portions 704, which each have the same radius of curvature. The radius of curvature for the inner arcuate portions is different from the radius of curvature for the outer arcuate portions 704, but the inner arcuate portions and outer arcuate portions should share generally the same center. The inner portions 702 and the outer arcuate portions 704 are then connected to each other by radially extending portions 706. This results in a circular crenellated shape. The term “crenellated” or “castellated” are not used herein as requiring the inner arcuate portions, outer arcuate portions, and radially extending portions to be straight lines, but rather to refer to the general up-and-down or in-and-out shape of the second rigid structural member 612. The first internal ribs 616 connect to the second rigid structural member 612 along the outer arcuate portions 704, while the second internal ribs 618 connect to the second rigid structural member 612 along the inner arcuate portions 704. As will be explained further herein, this structure forms two sets of mixing lobes, high energy mixing lobes and low energy mixing lobes. It should be noted that the crenellated shape may be only part of the second rigid structural member, and that the second rigid structural member could be shaped differently further upstream of the crenellated shape.

Referring now to FIG. 6, the ejector shroud sub-skeleton 603 includes an ejector shroud front ring structure or first rigid structural member 604, a plurality of first internal ribs 606, and a second rigid structural member 608. Again, an ejector shroud ring 610, which may be formed as a truss, may be included to further define the shape of the ejector shroud, and provide a connecting point between the turbine shroud sub-skeleton 601 and the ejector shroud sub-skeleton 603. When present, the ring truss 610 is substantially parallel to the ejector shroud front ring structure 604 and disposed normal to the turbine axis. The first rigid structural member 604, ring truss 610, and second rigid structural member 608 are all connected to each other through the plurality of first internal ribs 606, only one of which is shown in FIG. 6. The first rigid structural member 604 and the second rigid structural member 608 are generally parallel to each other and normal to the turbine axis.

The ejector shroud front ring structure 604 defines a front or inlet end 605 of the ejector shroud sub-skeleton 603. The ejector shroud rear ring structure 608 defines a rear end, outlet end, or exhaust end 607 of the ejector shroud sub-skeleton 603. The exhaust end 607 of the ejector shroud rear ring structure 608 also defines a rear end, exit end, or exhaust end of the overall skeleton 600. The ejector shroud front ring structure 604 defines a leading edge of the ejector shroud. Both the first rigid structural member 604 and the second rigid structural member 608 are substantially circular.

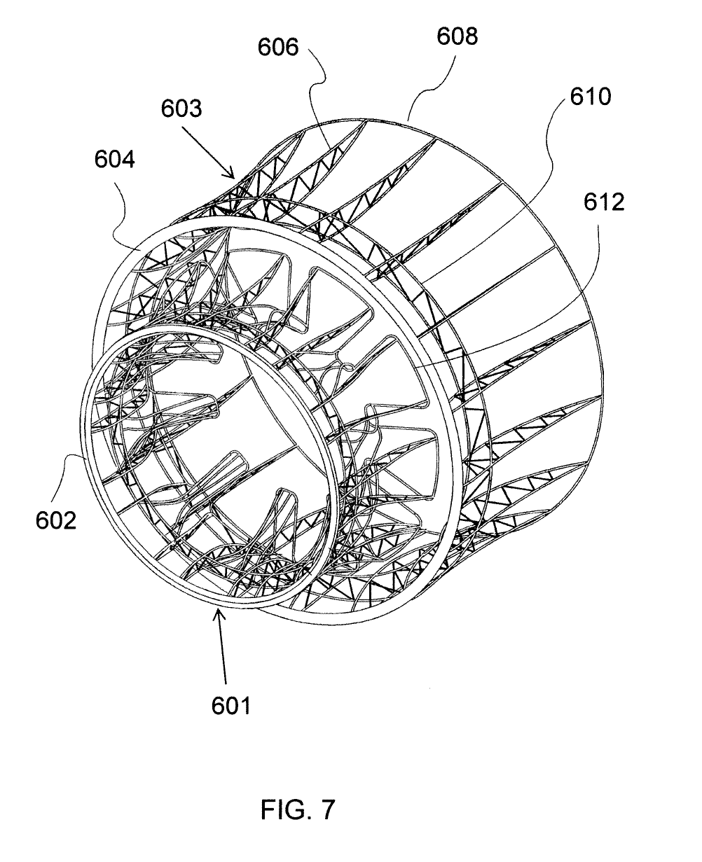

FIG. 7 shows both sub-skeletons 601, 603 in an assembled state, without the skins on either the turbine shroud or the ejector shroud.

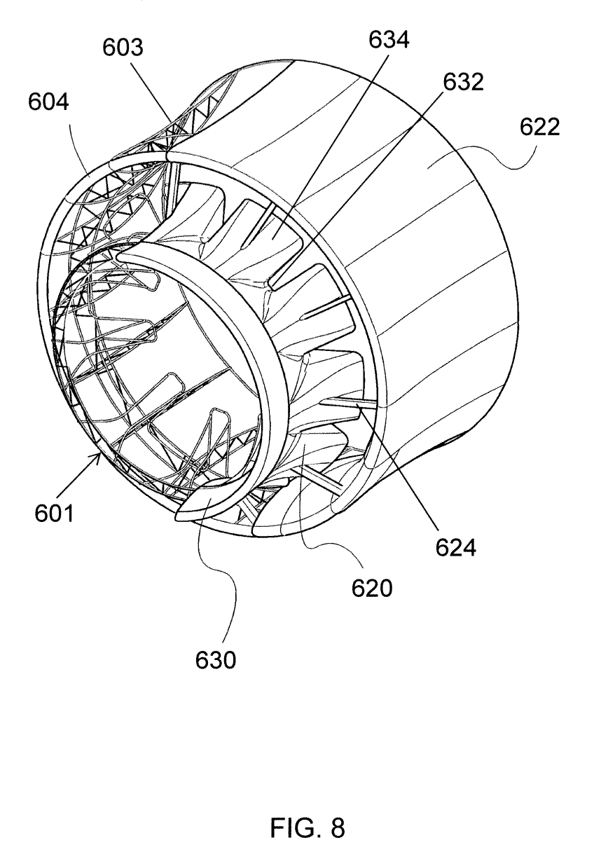

FIG. 8 illustrates the sub-skeletons with the skin partially applied. A turbine skin 620 partially covers the turbine shroud sub-skeleton 601, while an ejector skin 622 partially covers the ejector shroud sub-skeleton 603. The stretching of the turbine skin 620 over the sub-skeleton 601 forms the mixing lobes. The resulting turbine shroud 630 has two sets of mixing lobes, high energy mixing lobes 632 that extend inwards toward the central axis of the turbine, and low energy mixing lobes 634 that extend outwards away from the central axis. Support members 624 are also shown that connect the turbine shroud sub-skeleton 601 to the ejector shroud sub-skeleton 603. The support members 624 are connected at their ends to the turbine shroud ring truss 614 (see FIG. 5) and the ejector shroud ring truss 610.

If desired, the ejector shroud may also include a plurality of ejector shroud second internal ribs, which will allow for the formation of mixing lobes on the ejector shroud as well. Such a structure is directly analogous to the mixing lobes formed on the turbine shroud.

The skin 620, 622, respectively, of both the turbine shroud and the ejector shroud may be generally formed of any polymeric film or fabric material. Exemplary materials include polyvinyl chloride (PVC), polyurethane, polyfluoropolymers, and multi-layer films of similar composition. Stretchable fabrics, such as spandex-type fabrics or polyurethane-polyurea copolymer containing fabrics, may also be employed.

Polyurethane films are tough and have good weatherability. The polyester-type polyurethane films tend to be more sensitive to hydrophilic degradation than polyether-type polyurethane films. Aliphatic versions of these polyurethane films are generally ultraviolet resistant as well.

Exemplary polyfluoropolymers include polyvinyldidene fluoride (PVDF) and polyvinyl fluoride (PVF). Commercial versions are available under the trade names KYNAR® and TEDLAR®. Polyfluoropolymers generally have very low surface energy, which allow their surface to remain somewhat free of dirt and debris, as well as shed ice more readily as compared to materials having a higher surface energy.

The skin may be reinforced with a reinforcing material. Examples of reinforcing materials include but are not limited to highly crystalline polyethylene fibers, paramid fibers, and polyaramides.

The turbine shroud skin and ejector shroud skin may independently be multi-layer, comprising one, two, three, or more layers. Multi-layer constructions may add strength, water resistance, UV stability, and other functionality. However, multi-layer constructions may also be more expensive and add weight to the overall wind turbine.

The skin may cover all or part of the sub-skeleton; however, the skin is not required to cover the entire sub-skeleton. For example, the turbine shroud skin may not cover the leading and/or trailing edges of the turbine shroud sub-skeleton. The leading and/or trailing edges of either shroud sub-skeleton may be comprised of rigid materials. Rigid materials include, but are not limited to, polymers, metals, and mixtures thereof. Other rigid materials such as glass reinforced polymers may also be employed. Rigid surface areas around fluid inlets and outlets may improve the aerodynamic properties of the shrouds. The rigid surface areas may be in the form of panels or other constructions.

Film/fabric composites are also contemplated along with a backing, such as foam.

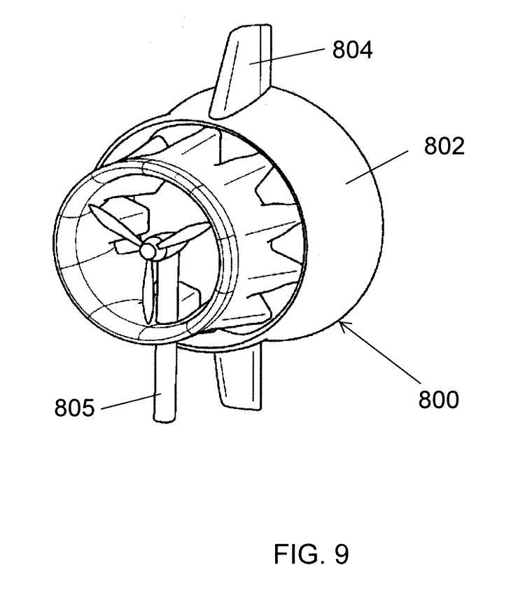

As shown in FIG. 9, another exemplary embodiment of a wind turbine 800 is shown with an ejector shroud 802 that has internal ribs kin fins or shaped to provide wing-tabs 804. The wing-tabs 804 are disposed downstream of the vertical support 805 and pivot to create a turning movement to optimally align or “weather vane” the wind turbine 800 with the incoming wind flow to improve energy or power production. The wind turbine is shown mounted to a support tower 805.

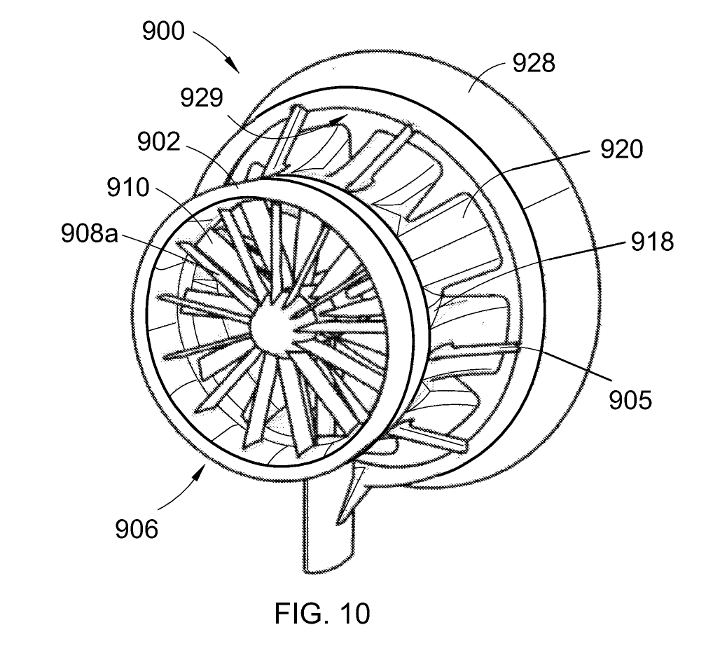

FIGS. 10-12 illustrate another exemplary embodiment of a shrouded wind turbine. The turbine indicated generally at 900 in FIG. 10 has a stator 908a and rotor 910 configuration for power extraction. A turbine shroud 902 surrounds the rotor 910 and is supported by or connected to the blades or spokes of the stator 908a. The turbine shroud 902 has the cross-sectional shape of an airfoil with the suction side (i.e. low pressure side) on the interior of the shroud. An ejector shroud 928 is coaxial with the turbine shroud 902 and is supported by connector members 905 extending between the two shrouds. An annular area is thus formed between the two shrouds. The rear or downstream end of the turbine shroud 902 is shaped to form two different sets of mixing lobes 918, 920. High energy mixing lobes 918 extend inwardly towards the central axis of the mixer shroud 902; and, low energy mixing lobes 920 extend outwardly away from the central axis.

Free stream air indicated generally by arrow 906 passing through the stator 908a has its energy extracted by the rotor 910. High energy air indicated by arrow 929 bypasses the shroud 902 and stator 908a and flows over the turbine shroud 902 and directed inwardly by the high energy mixing lobes 918. The low energy mixing lobes 920 cause the low energy air exiting downstream from the rotor 910 to be mixed with the high energy air 929.

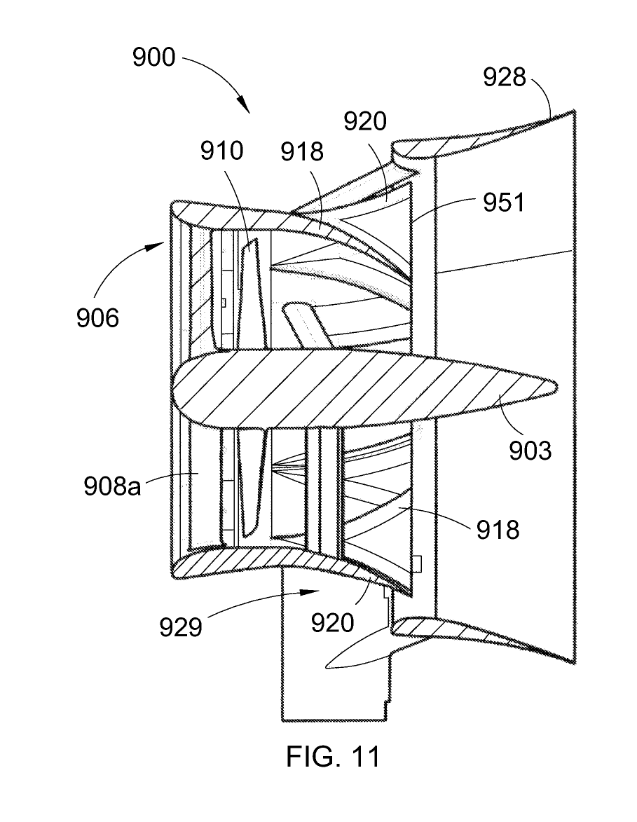

Referring to FIG. 11, the center nacelle 903 and the trailing edges of the low energy mixing lobes 920 and the trailing edge of the high energy mixing lobes 918 are shown in the axial cross-sectional view of the turbine of FIG. 10. The ejector shroud 928 is used to direct inwardly or draw in the high energy air 929. Optionally, nacelle 903 may be formed with a central axial passage therethrough to reduce the mass of the nacelle and to provide additional high energy turbine bypass flow.

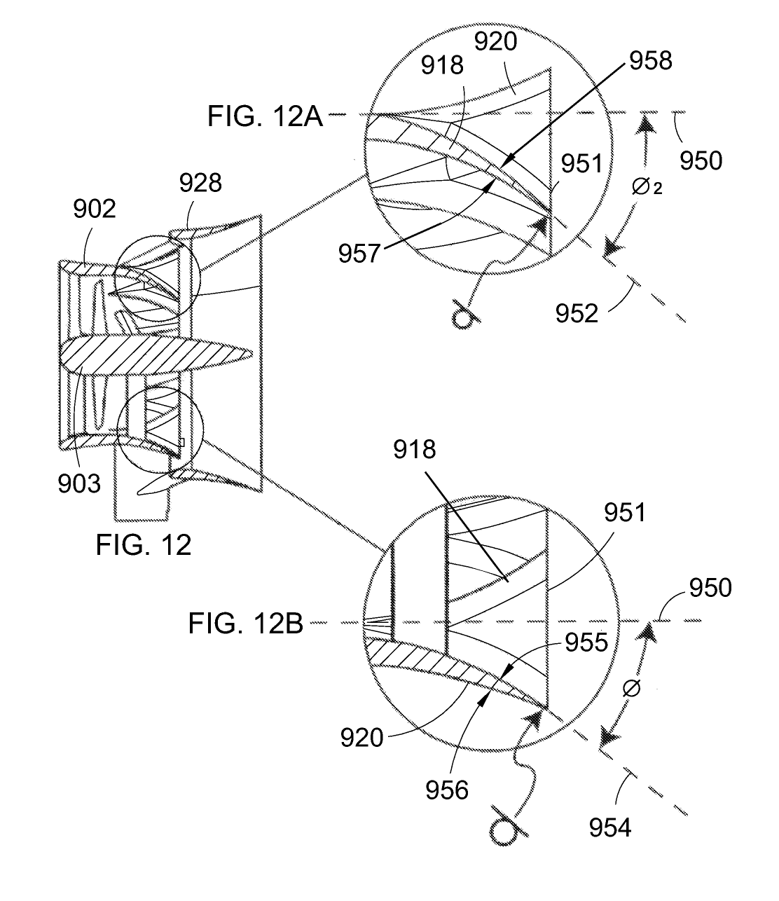

In FIG. 12A, a tangent line 952 is drawn along the interior trailing edge indicated generally at 957 of the high energy mixing lobe 918. A rear plane 951 of the turbine shroud 902 is present. A line 950 is formed normal to the rear plane 951 and tangent to the point where a low energy mixing lobe 920 and a high energy mixing lobe 918 meet. An angle Ø₂ is formed by the intersection of tangent line 952 and line 950. This angle Ø₂ is between 5 and 65 degrees. Put another way, a high energy mixing lobe 918 forms an angle Ø₂ between 5 and 65 degrees relative to the turbine shroud 902.

In FIG. 12B, a tangent line 954 is drawn along the interior trailing edge indicated generally at 955 of the low energy mixing lobe 920. An angle is formed by the intersection of tangent line 954 and line 950. This angle Ø is between 5 and 65 degrees. Put another way, a low energy mixing lobe 920 forms an angle Ø between 5 and 65 degrees relative to the turbine shroud 902.

The wind turbines of the present disclosure, which have shrouds made using a skeleton-and-skin construction, provide unique benefits over existing systems. The disclosed wind turbine provides a more effective and efficient wind generating system, and significantly increases the maximum power extraction potential. The wind turbine is quieter, cheaper, and more durable than an open bladed turbine of the comparable power generating capacity. The disclosed wind power system operates more effectively in low wind speeds and is more acceptable aesthetically for both urban and suburban settings. The disclosed wind turbine reduces bird strikes, the need for expensive internal gearing, and the need for turbine replacements caused by high winds and wind gusts. As compared to existing wind turbines, the design is more compact and structurally robust. The disclosed turbine is less sensitive to inlet flow blockage and alignment of the turbine axis with the wind direction and uses advanced aerodynamics to automatically align itself with the wind direction. Mixing of high energy air and low energy air inside the disclosed turbine increases efficiency which reduces downstream turbulence.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A wind turbine including a turbine shroud, the turbine shroud comprising:
a turbine shroud fire rigid structral member;
a turbine shroud second rigid structural member:
a plurality of internal ribs connecting the first rigid structural member to the second rigid structural member; and
a turbine skin covering at least a portion of the plurality of first internal ribs, wherein the skin comprises a fabric or a polymer.

2. The wind turbine of claim 1, further comprising an ejector shroud and at least one truss connecting the ejector shroud to the turbine shroud; wherein the ejector shroud comprises:
an ejector shroud first rigid structural member.
an ejector shroud second rigid structural member;
a plurality of second internal ribs connecting the ejector shroud first rigid structural member to the ejector shroud second rigid structural member; and
an ejector skin covering at least a portion of the plurality of second internal ribs, the skin comprising a fabric or a polymer.

3. The wind turbine of claim 2, wherein the turbine shroud first rigid structural member and the ejector shroud first rigid structural member each have a substantially circular shape.

4. The wind turbine of claim 2, wherein the ejector shroud second rigid structural member has a crenellated shape, and the plurality of second internal ribs are shaped so as to form mixing lobes on the ejector shroud.

5. The wind turbine of claim 1, wherein a leading edge of the turbine shroud and a trailing edge of the turbine shroud are not covered by the turbine skin.

6. The wind turbine of claim 1, further comprising an impeller; wherein the turbine shroud is disposed about the impeller.

7. The wind turbine of claim 1, wherein the turbine skin comprises a film of polyurethane-polyurea copolymer material.

8. The wind turbine of claim 1, wherein the turbine skin is reinforced with a highly crystalline polyethylene, para-aramid fibers, or a polyaramide material.

9. The wind turbine of claim 1, wherein the turbine shroud second rigid structural member has a crenellated shape, and the plurality of first internal ribs are shaped so as to form mixing lobes on the turbine shroud.

10. The wind turbine of claim 1, wherein a leading edge of the turbine shroud and a trailing edge of the turbine shroud are formed of a rigid material.

11. The wind turbine of claim 10, wherein the rigid material is selected from the group consisting of polymers, metals, and mixtures thereof.

12. The wind turbine of claim 10, wherein the rigid material is a glass reinforced polymer.

13. The wind turbine of claim 1, wherein the turbine skin comprises a plurality of layers.

14. A wind turbine comprising a turbine shroud, an ejector shroud, and at least one truss connecting the turbine shroud to the ejector shroud;
wherein the turbine shroud comprises:
a first rigid structural member defining a leading edge of the turbine shroud;
a second rigid structural member defining a trailing edge of he turbine shroud;
a plurality of first internal ribs connecting the first rigid structural member to the second rigid structural member; and
a turbine shroud skin covering at least a portion of the plurality of first internal ribs, and comprising a fabric or a polymer;
wherein the ejector shroud comprises:
an ejector shroud first rigid structural member defining a leading edge of the ejector shroud;
an ejector shroud second rigid structural member defining a trailing edge of the ejector shroud;
a plurality of second internal ribs connecting the ejector shroud first rigid structural member to the ejector shroud second rigid structural member; and
an ejector shroud skin covering at least a portion of the plurality of second internal ribs, and comprising a fabric or a polymer;
wherein the first rigid structural member and the ejector shroud first rigid structural member each have a substantially circular shape; and
wherein the second rigid structural member and the ejector shroud second rigid structural member each have a circular crenellated circumference.

15. The wind turbine of claim 14, further comprising an impeller; wherein the turbine shroud is disposed about the impeller.

16. The wind turbine of claim 14, wherein the turbine shroud skin and the ejector shroud skin are formed of a polyurethane-polyurea copolymer material.

17. The wind turbine of claim 14, wherein the turbine shroud fabric skin and the ejector shroud fabric skin are reinforced with a highly crystalline polyethylene, para-aramid fibers, or a polyaramide.

18. The wind turbine of claim 14, wherein the turbine shroud fabric skin and the ejector shroud fabric skin are reinforced with a polyvinyl chloride resin.

19. The wind turbine of claim 14, wherein the leading edge of the turbine shroud, trailing edge of the turbine shroud, leading edge of the ejector shroud, and trailing edge of the ejector shroud are formed of a rigid material.

20. A method of making a wind turbine comprising:
(a) providing an impeller;
(b) forming a skeleton and covering at least a portion of the skeleton with a skin to form a turbine shroud, the skin comprising a fabric or a polymer film; and
(c) disposing the shroud about the impeller.

21. The method of claim 20, wherein the step of forming a skeleton includes providing a first rigid circular member and a second rigid circular member, and connecting the first and second annular members with a plurality of spaced ribs.

22. The method of claim 21, wherein the step of connecting the annular members with spaced ribs includes forming at least one high-energy mixing lobe and at least one low-energy mixing lobe.

23. The method of claim 21, wherein the second rigid circular member forms a crenellated shape on a downstream edge of the turbine shroud.

24. The method of claim 20, further comprising disposing an ejector shroud about the turbine shroud, an outlet end of the turbine shroud extending into an inlet end of the ejector shroud.

25. The method of claim 24, wherein the ejector shroud is formed by providing an ejector skeleton and covering at least a portion of the ejector skeleton with a skin, the skin comprising a fabric or a polymer film.

26. The method of claim 25, wherein the ejector skeleton is formed by providing a first rigid circular member and a second rigid circular member, and connecting the first and second annular members with a plurality of spaced ribs.

27. The method of claim 26, wherein the step of spaced ribs of the ejector skeleton are axially extendable.

28. The method of claim 25, wherein the ejector skeleton second rigid circular member forms a crenellated shape on a downstream edge of the ejector shroud.
